(19) United States
(12) Patent Application Publication
(10) Pub. No.: US 2019/0394847 A1
(43) Pub. Date: Dec. 26, 2019

(54) VARIABLE LIGHTING SYSTEM

(71) Applicants: Glenn Jakins, Provo, UT (US); Lloyd Wilford, Assagay (ZA)

(72) Inventors: Glenn Jakins, Provo, UT (US); Lloyd Wilford, Assagay (ZA)

(21) Appl. No.: 16/013,814

(22) Filed: Jun. 20, 2018

(51) Int. Cl. H05B 33/08; H02J 3/38; H02J 7/00

(52) U.S. Cl. CPC H05B 33/0845; H02J 7/0068; H02J 3/386; H02J 3/383

(57) ABSTRACT

A variable lighting system is described that uses LEDs in conjunction with one or more power sources, including variable power sources.

### BACKGROUND

Lighting presents a whole host of challenges, whether it be for everyday use or special occasion. In some cases, lighting may be sought that is natural or that has a desired intensity level. Also, lighting that is sustained for long periods of time may be desirable. With environmental concerns on the rise, energy efficiency is of concern. Considerations of temperature are also important to obtain the maximum life of a light source. Also, lighting that is adaptable with varying circumstances may be useful. With diverse features and varying circumstances to be considered, improvements in lighting systems are needed.

### SUMMARY

An exemplary LED lighting system comprises a first set of one or more LEDs and a second set of one or more LEDs, where the second set of LEDs provides less illumination than the first set of LEDs. The system further includes an electrical power source with voltage that varies below and above a predetermined voltage value, the variation in voltage due to a change external to the lighting system. A control circuit activates the first set of LEDs when the voltage of the electrical power source is above the predetermined voltage. The control circuit activates the second set of LEDS when the voltage of the electrical power source is below the predetermined voltage.

Another exemplary LED lighting system includes a circuit, a first set of one or more LEDs connected to the circuit and configured for a first voltage range and a second set of one or more LEDs connected to the circuit and configured for a second voltage range that is higher than the first voltage range. The first set of one or more LEDs is lighted when a voltage in the first voltage range is applied, and the first and second set of one or more LEDs is lighted when a voltage in the second voltage range is applied. The lighting system further includes at least one heat sink that absorbs and dissipates heat from the system and thereby regulates temperature of the system.

The system contemplates the use of one power source or multiple power sources, such as a combination of a solar panel and a battery. Also, multiple batteries and solar panels are contemplated, as well as other power sources, such as the grid, wind generated power, locally generated hydropower, and the like. The one or more power sources are coordinated by a circuit to light either one or both first and second sets of LEDs. In addition, if one of the power sources is a battery, the system can be programmed to charge the battery from the other power source. For example, depending on voltage values from the power sources, (1) LEDs can be selectively lighted directly from a solar panel, (2) a battery can be charged, and/or (3) lighting of the LEDs can be reduced to conserve battery life or to respond to low light conditions (e.g., lighting can be limited to one or more LEDs or brightness of lighting can be reduced, etc.).

### BRIEF DESCRIPTION OF DRAWINGS

FIG. 1 shows an exemplary lighting system.

FIG. 2 shows an exemplary lighting system.

FIG. 3 shows an exemplary lighting system.

FIG. 4 shows an exemplary lighting system.

FIG. 5 shows an exemplary lighting system.

FIG. 6 shows an exemplary lighting system.

FIG. 7 shows an exemplary lighting system.

FIG. 8 shows an exemplary lighting system.

FIG. 9 shows a circuit diagram.

FIG. 10 shows a circuit diagram.

FIG. 11 shows a graph of current versus voltage.

FIG. 12 shows a graph of a thermal response of a circuit module.

### DETAILED DESCRIPTION

The emergence of high brightness light emitting diodes (LEDs) has led the conventional lighting world into a new era of lighting. High optical efficiency, long operating lifetime, wide operating temperature range, and environmental friendliness are only some of the key features in favor of LED technology over incandescent or fluorescent solutions.

The following includes an LED lighting system that provides light in a manner that allows for a range of input voltages and a variety of power sources. For example, the system includes a circuit that works with both panel voltage, such as the voltage from a solar panel, as well as battery voltage. The system further functions with both AC and DC current. By having a long life, a high efficiency, and an optimal operating temperature, the system has the potential to replace most commercial and domestic lighting systems.

An exemplary LED lighting system comprises a first set of one or more LEDs and a second set of one or more LEDs, where the second set of LEDs provides less illumination than the first set of LEDs. The system further includes an electrical power source with voltage that varies below and above a predetermined voltage value, the variation in voltage due to a change external to the lighting system. A control circuit activates the first set of LEDs when the voltage of the electrical power source is above the predetermined voltage. The control circuit activates the second set of LEDS when the voltage of the electrical power source is below the predetermined voltage.

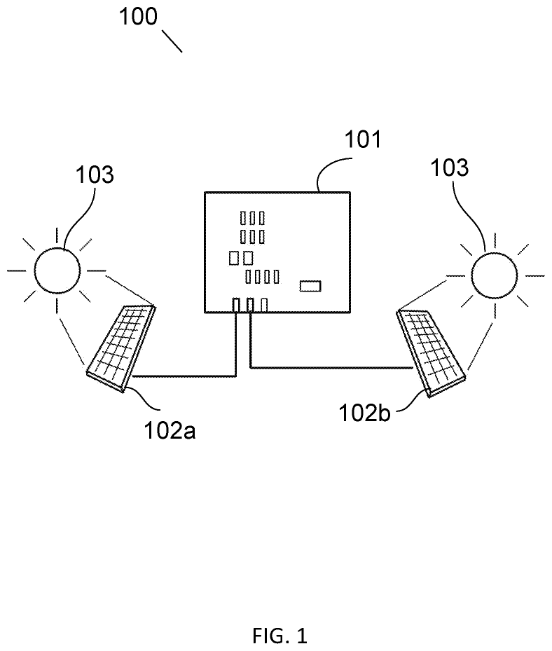

An exemplary arrangement for the lighting system 100 includes a dual panel skylight as shown in FIG. 1. Two solar or photovoltaic (PV) panels 102a and 102b are positioned so as to receive light and convert it to electricity. As shown, the panels 102a and 102b face different directions to maximize the hours facing the sun 103 and hence the hours of light from “skylight.” This may be accomplished by positioning the panels on either side of a roof, for example. A module 101 takes all or most of the available current from both panels 102a and 102b and is configured to ensure that no current from one panel can flow into the second panel. For maximum efficiency, one panel faces east and the other faces west. 2×12V, 15 W-20 W panels provide sufficient power for a single module for both full sun and moderately overcast conditions.

Additional modules can simply be paralleled on a set of larger PV panels for higher lumen output in either a single light fitting or several individual lights.

The electrical power source may come from one or more of a variety of sources. For example, the source may include one or more of solar panels, wind generators, and hydro-generators. Various modes by the lighting system may be achieved, including at least one or more of the following—

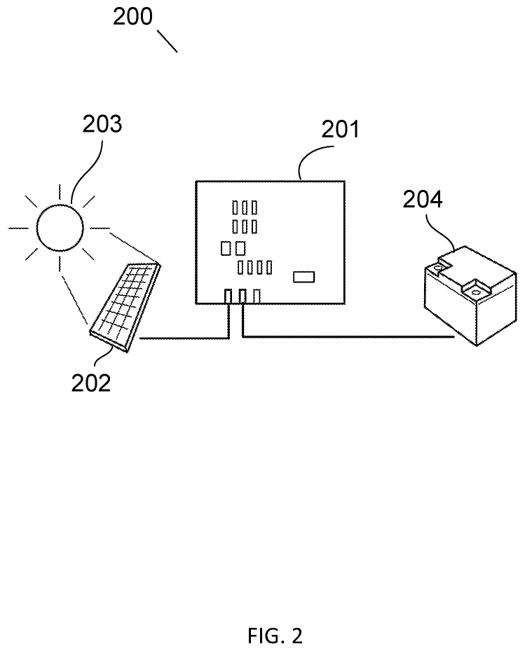

Turning to FIG. 2, lighting system 200 includes PV panel 202 configured to supply power from sun 203 to module 201 during the daytime at full output. Battery 204 is configured to take over or supplement the supply from panel 202 at a lower lumen output when insufficient or no power becomes available from the panel 202. The system may be configured such that power is first derived from the PV panel 202 and only if insufficient will the balance of the power be sourced from the battery 204.

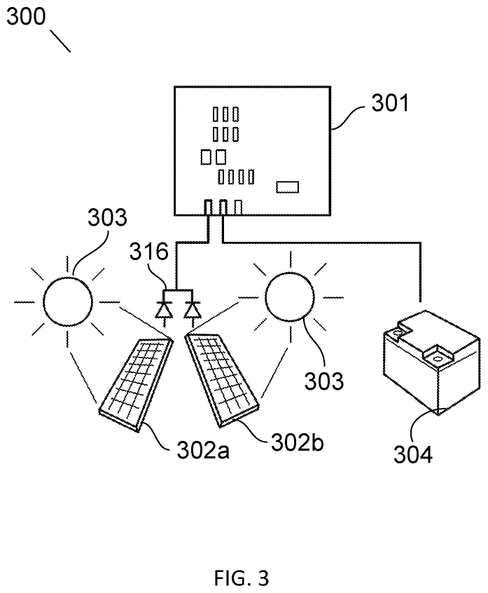

A system like the one shown in FIG. 2 can be a dual PV system that is constructed with a battery like the system 300 in FIG. 3. PV panels 302a and 302b are configured to supply power from sun 303 to module 301 with battery 304 configured to supply power as a backup. In this case, two additional diodes 318 are recommended to be used for the module 301. The system may further be configured to reverse current to the storage battery and charge the storage battery when the voltage exceeds a threshold voltage value that is greater than a predetermined voltage value.

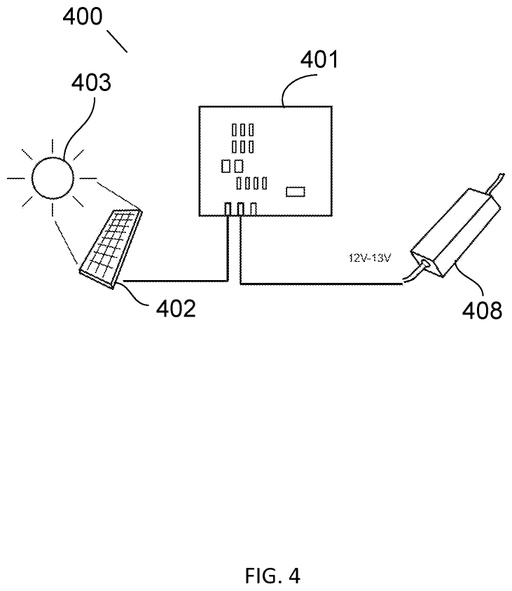

Turning to FIG. 4, system 400 includes a PV panel 402 that is combined with a power supply unit (PSU). As shown, the power supply unit may take the form of a DC supply 408. Furthermore, the DC supply 408 may have a 12-13V supply, for example.

During the day, module 401 is powered by the sun 403 through the PV panel 402 at full output while a PSU 408 remains in standby mode consuming almost nothing. During the night the PSU 408 powers the module 401 at a reduced output. A higher lumen output during the day is often advantageous, as the surrounding ambient light is much higher and “fill” lighting needs to be brighter than when the surrounding ambient lighting is lower.

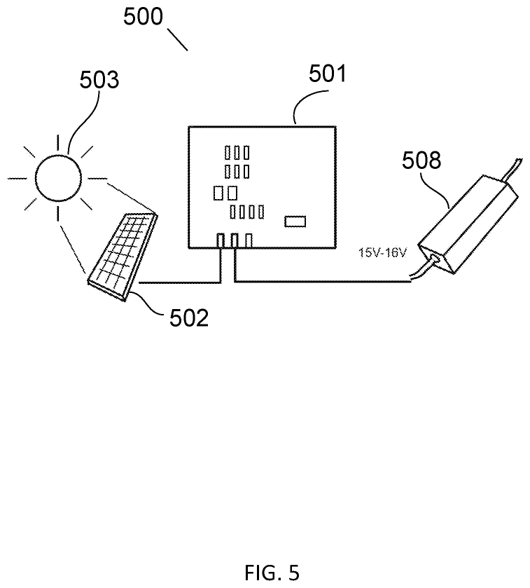

If full lumen output is required all day and night, a module may be used with a 15V-16V dc power supply. As shown in FIG. 5, module 501 is powered by the sun 503 through PV panel 502 while PSU 508 remains in standby mode for use later.

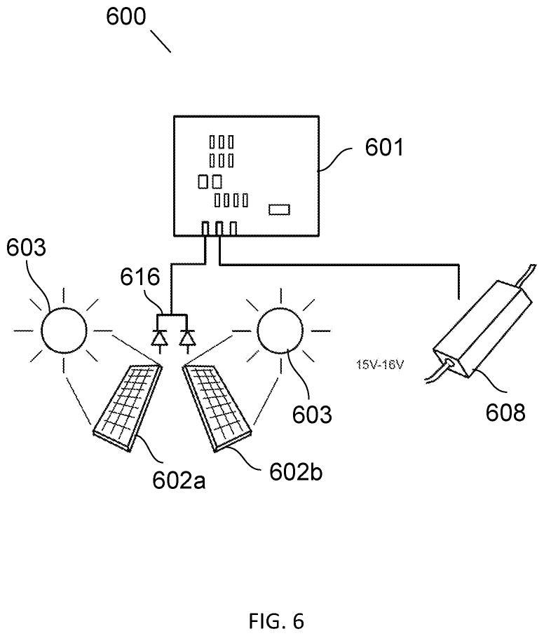

A dual PV system can also be constructed together with a power supply, such as a 12-13V or 15-16V supply. Such a system 600 is shown in FIG. 6 in which module 601 is connected to PV panel 602a and 602b to be powered by sun 603 while PSU 608 remains in standby mode. Additional diodes 616 are used in conjunction with the dual system.

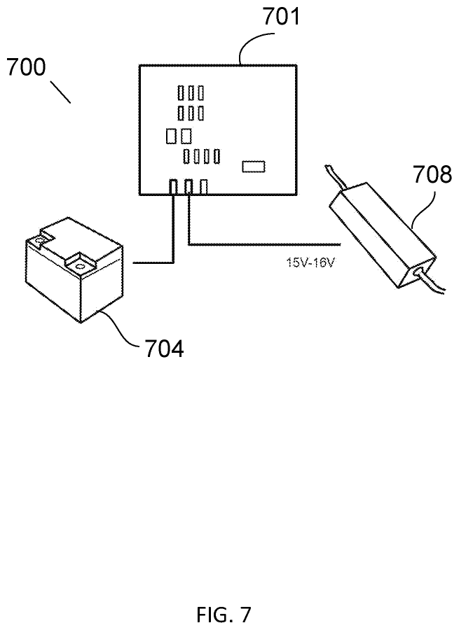

Turning to FIG. 7, module 701 is powered by PSU 708 under normal power conditions. Under power fail, the module 701 is powered by a battery 704. The battery 704 is configured to provide power at a reduced lumen output. Power may alternatively be provided as a normal power or variable power.

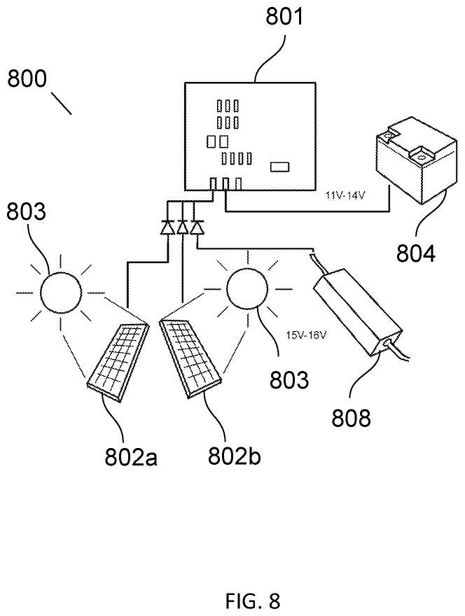

Turning to FIG. 8, module 801 runs on sun 803 from dual PV panels 802a and 802b during the day and PSU 808 at night and provides emergency lighting with battery 804 if the power fails.

At least the following modes are present—

Skylight Mode

This mode allows a user to take solar panel voltage and translate the light directly indoors without the need for AC or batteries at a color temperature close to sunlight. It also has a unique feature of a double positive input so that the user is able to use two PV solar panel sources to translate an east-west (or any double) configuration.

Full Day and Night Mode

The system may include a switchable input that allows the user to switch to the lower voltage power source. For example, this mode may allows a user to use a switchable input to use a DC source to supply power at night.

Self-Sustaining Full Off Grid Mode

This mode allows a user to use a solar panel and battery to charge the system. The user can use one of the two positives on the input side of charge to run directly on solar panels during the day and therefore not use any batteries. Only excess charge is then put into the batteries. The second positive is on the output of the charger and can operate both night and day on the battery voltage. The second positive can supplement the day light level and run at night. As a result, a 24 hour, 7 days a week lighting source that is independent of the national grid is possible.

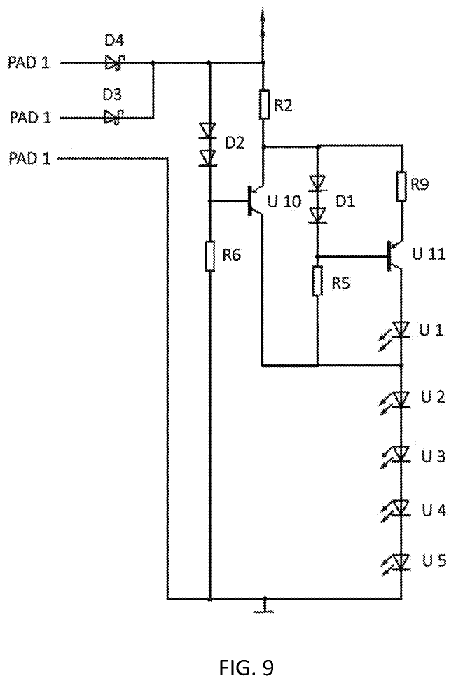

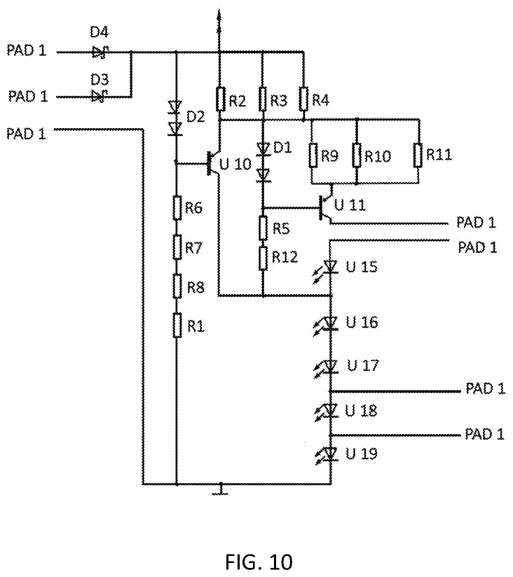

Exemplary circuits for the lighting system are shown in FIGS. 9 and 10. The circuit is arranged in such a manner that a string of four LEDs connected in series is supplied by a first current limiting element U10 at a lower voltage, and once a sufficient voltage is developed across the first current limiting element, the second current limiting element U11 allows or takes over connecting a fifth LED to the series chain. The circuit in FIG. 9 depicts the four LEDS U2, U3, U4, and U5 and fifth LED U1 along with current limiting elements, as depicted by exemplary elements shown as diodes D2, resistor R2, resistor R6, PNP transistor U10, diode D1, resistor R9, resistor R5, and PNP transistor U11. At least two inputs a negative terminal may be used as indicated by inputs PAD1. As shown, a dual input of D3 and D4 are provided to allow two power sources to be safely connected with the circuit favoring the supply with the higher voltage.

Other types of limiting devices and arrangements are anticipated as known in the art. For example, schematic in FIG. 10 presents an equivalent circuit using NPN transistors. Four LEDs U16, U17, U18, and U19 and fifth LED U11 along with current limiting elements, as depicted by exemplary elements shown as diodes D2, D3, and D4; resistors R2, R3, R4, R5, R6, R7, R8, R9, R10, R11, and R12; and NPN transistors U10 and U11.

The voltage range for either or both set of LEDs may include voltages for 10 V, 11 V, 12 V, 13 V, 14 V, 15 V, 16 V, 17 V, 18 V, 19 V, 20 V, 21 V, 22 V, 23 V, 24 V, and 25 V. The range may include any one of the voltages listed. In one embodiment, the system is configured for use with a voltage or voltage range, such as a 10 to 14 voltage range, or other voltage range. At least a first set of one or more LEDs may be configured for use with an 11 V to 13.6 V range and a second set of one or more LEDs connected to the circuit may be configured for a 14 to 24 voltage range, the second LED configured to light up along with the first set of LEDs when the voltage applied exceeds the voltage range for the first LEDs. At least one heat sink absorbs and dissipates heat from the system and thereby regulates temperature of the system. In this manner, the second LED allows the circuit module to absorb high voltages. For example, the second LED can absorb high voltages from a solar panel.

Although five LEDs are shown, the number of LEDs may vary. The circuit module may include additional components or a variation on the components shown, such as a combination of both PNP transistors and NPN transistors. There is no task controller shown in between the input and negative terminal, however some examples may include one or more task controllers.

In one variation, a third set of LEDs is connected to the circuit where the LEDs and circuit are configured to light the LEDs in the third set for a third voltage range.

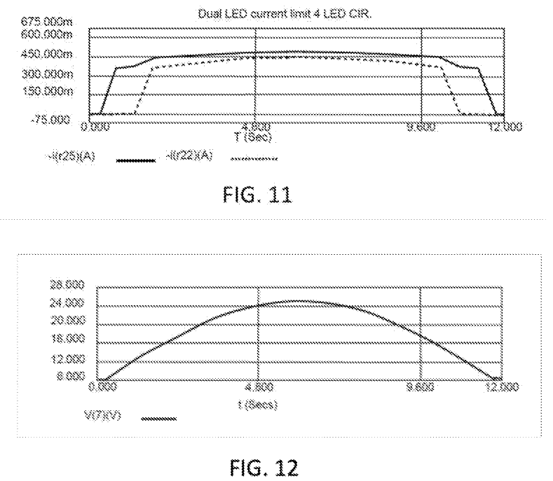

As depicted in FIG. 11, two simulations are graphed. The four LED chain has a varying current versus time as represented by the upper solid line in the top graph. The 5^{th} LED has a varying current versus time as represented by the lower dotted line in the FIG. 11. The varying voltage being applied to the four LED chain versus time is the parabolic line in the graph of FIG. 12. In other words, the LED current for the 4th LED chain and the 5^{th} LED reflects a varying voltage. From the graphs, it can be readily appreciated that at lower voltages, no current flows through the 5th LED. Also, the current is kept relatively constant when the higher voltage is applied to the circuit, protecting the LED from overload.

In order to make an effective skylight, the following elements are considered—

Longevity

LEDs themselves can last for several hundred thousand hours, well over 10 years, with little reduction in efficiency, however, the circuitry driving the LED's is often not capable of such a long life. The shorter life of the circuitry is often due to the use of switching circuits that require capacitors which have limited life expectancy, particularly at high temperature. The circuit described herein requires no capacitors, and all components (other than the LEDs) will perform their function at a temperature above 100 degrees C. and will therefore not suffer from this problem. Quality LEDs may be used, such as the Osram SSL series LEDs.

Efficiency

The circuit module may use devices that run in a linear mode, but unlike typical linear designs, the circuit module realizes very high efficiency out of the luminary between 10 V and 16 V. It can do this by switching between multiple LEDs, such as the exemplary 4 and 5 LEDs in series. An exemplary electrical power source is a solar panel and the change is an automatic switching from the solar panel to a lower voltage power source. Automation may be used with other power sources as well, such as a battery. Switching may be manual or a hybrid of automation and manual operation.

Efficiency is important because as a skylight, one needs all the light possible when the solar panel is in the more oblique angles to the sun (morning and evening), or on cloudy days. The efficiency drops above 16V, however, but at this point the luminary has reached the maximum brightness and efficiency is no longer important.

Temperature and Heat Sink

In one embodiment, the LEDs are kept below 85 degrees by heat sinking and thus the LEDs realize a maximum life and achieve a goal of up to 100,000 hours of life or more.

In free air, an exemplary heat sink may be approximately 22,500 mm² (150 mm×150 mm). Increased surface area can be achieved by including fins on the plate. Other means of increasing surface area are also readily known in the art.

In FIG. 4, an exemplary response is shown of the thermal response of the circuit. Of particular interest is that the response on a 150×150 mm×3 mm flat aluminum plate includes elected heat in the LEDs.

### Skylight Assembly

For an exemplary skylight assembly, a heat sink compound is used. Examples of a heat sink compound include thermal grease, silicone compound, zinc oxide compound, beryllium compound, or other material designed to absorb and dissipate heat commonly known in the art. An important location in which to sink the heat may be directly under the LEDs. In an example with 5 LED's, a small amount of the heat sink compound is placed under all 5 LED's. Also, a small amount of the heat sink compound is placed on both sides of a thermo pad insulator. It is important that no heat sink compound gets on an LED's silicone dome as this will cause a hot spot and effect the life of the LED. In general, the silicone dome of the LED should be protected from rubbing or knocking against anything as this is a delicate part and easily damaged.

In use, two or more solar panels may be included in a lighting system that uses an LED arrangement that incorporates a variable voltage feature described and that allows two or more voltage inputs. The solar panels may face different directions. For example, the solar panels may face opposite directions. One or more solar panels may face east and the other one or more solar panels face west. This arrangement may allow for the highest number of hours that the lighting system is fully on and also flattens out the inverted bathtub irradiation response of a panel mounted flat. Any number of angles from a horizontal may be used to configure the solar panels. For example, an angle range may be 30-35 degrees, 35-40 degrees, 40-45 degrees, 45-50 degrees, 50-55 degrees, 55-60 degrees, and 60-65 degrees are possible. Particularly, a 45 degree elevation (Tot 45) most likely provides the continuous or flattest response for the whole period of time from dawn to dusk (optimizing for winter).

For temperature, the lighting system may operate, for example, from ambient −40 degrees to 45 degrees. Note that the circuit modules should be sealed in an enclosure to protect the board from the elements (moisture and insect infestation).

One of the voltage sources may include a conventional solar panel voltage (e.g. 10-12 V panel, etc.) that is directly applied to the circuit. The panel may include an open voltage of 23 V and under a load of 15.8 V. Also, a conventional battery voltage (e.g. 11V, 12 V, 13 V, 13.6V, 14 V, 15 V, etc.) may act as a voltage that is directly applied to the circuit. A 12 V solar panel is essentially a current source below 15 V, so when connected together with a 15 V power supply (which is a voltage source), the scenario exists where the circuit module sources all the power it needs first from the solar panel and only if additional power is required will this be sourced from the power supply. This results in a very efficient hybrid use of power, and a light source available 24 hours, 7 days a week. The voltages described may vary from the voltages being described.

A single Master switch can be placed in the −Ve return for all variants. A power supply above 16V is not recommended because efficiency of the system will drop. If using LED power supplies, it is recommended that the maximum voltage output is limited to 16V and allow 0.4 A (7 W) per module. Provisions for charging the battery are well known in the art. It may be recommended to use additional diodes (e.g. 2 A, 60V schottky diodes)

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. A LED lighting system comprising,
a first set of one or more LEDs,
a second set of one or more LEDs where the second set of LEDs provides less illumination than the first set of LEDs,
an electrical power source with voltage that varies below and above a predetermined voltage value, the variation in voltage due to a change external to the lighting system,
a control circuit that activates the first set of LEDs when the voltage of the electrical power source is above the predetermined voltage, or activates the second set of LEDS when the voltage of the electrical power source is below the predetermined voltage.

2. The system of claim 1 wherein the electrical power source is one or more of solar panels, wind generators, and hydro-generators, and the change is a decrease in available current from the one or more of solar panels, wind generators, and hydro-generators.

3. The system of claim 1 wherein the electrical power source is a solar panel and the change is an automatic switching from the solar panel to a lower voltage power source.

4. The system of claim 3 wherein the lower voltage power source is a storage battery or a grid connected power supply.

5. An LED lighting system comprising:
a circuit;
a first set of one or more LEDs connected to the circuit where the LEDs and circuit are configured to light the LEDs in the first set for a first voltage range;
a second set of one or more LEDs connected to the circuit where the LEDs and circuit are configured to light the LEDs in the second set for a second voltage range.

6. The system of claim 1, wherein the second set of LEDs includes one or more LEDs that are also in the first set.

7. The system of claim 1, further comprising a third set of LEDs that is connected to the circuit where the LEDs and circuit are configured to light the LEDs in the third set for a third voltage range.

8. The system of claim 4, wherein the system is configured to reverse current to the storage battery and charge the storage battery when the voltage exceeds a threshold voltage value that is greater than the predetermined voltage value.

9. The system of claim 2, wherein the system is programmed for a skylight mode with the power source including a first power source facing a first direction and a second power source facing a second direction that is different from the first direction, the voltage supplied to the system being a combination of both the first and the second power source.

10. The system of claim 13, wherein the first power source faces an opposite direction from the second power source.

11. The system of claim 1, further comprising a switchable input that allows the user to switch to the lower voltage power source.

12. The system of claim 1, wherein the system is programmed with an off-grid mode, wherein an option is provided that allows the system to use a solar panel and battery to charge the system.

13. The system of claim 1, wherein the circuit is free of capacitors.

14. The system of claim 2, further comprising at least one or more additional diodes when the power source includes more than one source.
